(19) United States
(12) Patent Application Publication
(10) Pub. No.: US 2025/0013941 A1
(43) Pub. Date: Jan. 9, 2025

(54) DELIVERY ROUTE CREATION DEVICE

(71) Applicant: TOYOTA JIDOSHA KABUSHIKI KAISHA, Aichi-ken (JP)

(72) Inventors: Yohei NAKANISHI, Nagoya-shi (JP); Toshiharu FUKUMURA, Nagakute-shi (JP); Adrian NICOL, Nagoya-shi (JP); Ryuichi DANNO, Kasugai-shi (JP); Toshinori KIMURA, Ichinomiya-shi (JP); Yoshiaki ABE, Kofu-shi (JP)

(21) Appl. No.: 18/757,498

(22) Filed: Jun. 28, 2024

(30) Foreign Application Priority Data
Jul. 4, 2023 (JP) 2023-110009

(51) Int. Cl. G06Q 10/047; G06F 16/29; G06Q 10/08; H04W 4/021

(52) U.S. Cl. CPC G06Q 10/047; G06Q 10/08; H04W 4/021; G06F 16/29

(57) ABSTRACT

A delivery assistance device includes a controller and a second database that records position information about a rest area. The controller creates, as a delivery route, a route that satisfies both delivering goods to delivery destinations and allowing a delivery vehicle to go to the rest area at each predetermined time interval or at a predetermined rest time based on position information of the delivery destinations and the position information of the rest area.

### CROSS-REFERENCE TO RELATED APPLICATIONS

This application is based upon and claims the benefit of priority from prior Japanese Patent Application No. 2023-110009, filed on Jul. 4, 2023, the entire contents of which are incorporated herein by reference.

### BACKGROUND

### 1. Field

The present disclosure relates to a delivery route creation device that creates a delivery route of a delivery vehicle.

### 2. Description of Related Art

Japanese Laid-Open Patent Publication No. 2022-119392 discloses a system for assisting in planning to deliver goods by a delivery vehicle. The system performs delivery simulation on a plurality of delivery plans to calculate an index for evaluating the validity of the delivery plans.

The driver of the delivery vehicle performs the task of delivering goods in accordance with a set delivery plan. It is desirable that the driver take a rest at each predetermined time interval or at a predetermined time. However, the driver cannot take a rest unless the driver is in a place in which the delivery vehicle can be parked. When the driver is performing the delivery task in accordance with the delivery plan, there is a possibility that the delivery vehicle cannot arrive at a place in which the driver can take a rest at an appropriate timing.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides a delivery route creation device that creates a delivery route for delivering goods to delivery destinations by a delivery vehicle. The delivery route creation device includes a database that records position information about a rest area including a parking space where the delivery vehicle is allowed to be parked, the rest area being an area in which a driver of the delivery vehicle is allowed to rest, and a controller including processing circuitry. Based on position information about the delivery destinations and the position information about the rest area, the processing circuitry is configured to create a route, as the delivery route, that satisfies both delivering the goods to the delivery destinations, and allowing the delivery vehicle to go to the rest area at each predetermined time interval or at a predetermined rest time.

Other features and aspects will be apparent from the following detailed description, the drawings, and the claims.

### BRIEF DESCRIPTION OF THE DRAWINGS

FIG. 1 is a schematic configuration diagram illustrating a delivery assistance device, which is an embodiment of a delivery route creation device, a plurality of delivery vehicles, and a plurality of information terminals.

FIG. 2 is a diagram showing information recorded in a first database provided in the delivery assistance device of FIG. 1.

FIG. 3 is a diagram showing information recorded in a second database included in the delivery assistance device of FIG. 1.

FIG. 4 is a flowchart showing a series of processes executed by a controller included in the delivery assistance device of FIG. 1.

FIG. 5 is a sequence diagram illustrating a flow of a process of updating information recorded in a second database included in the delivery assistance device of FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

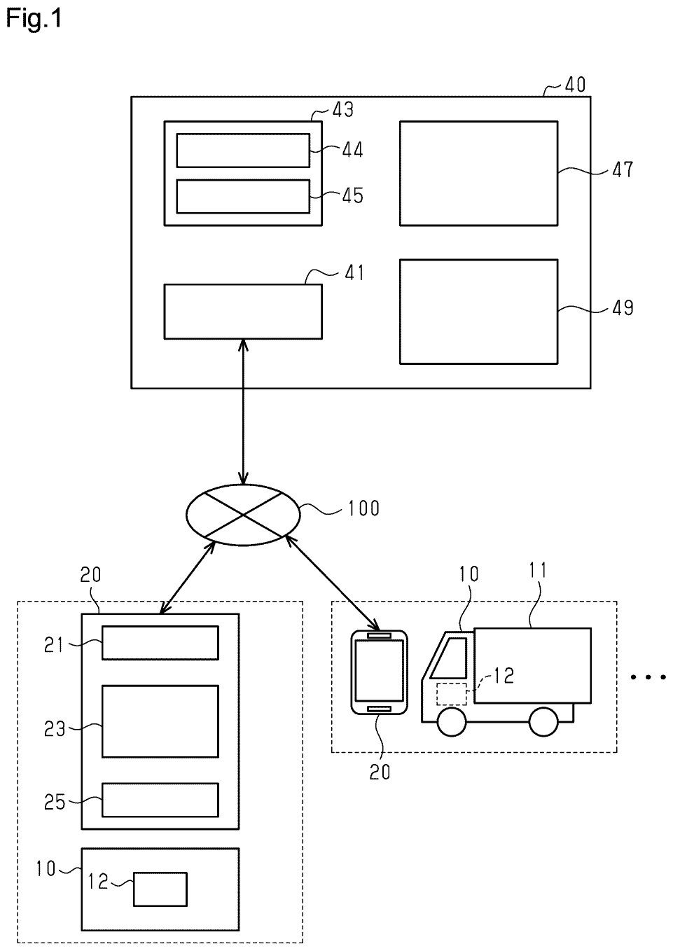

Hereinafter, an embodiment of a delivery route creating apparatus will be described with reference to FIGS. 1 to 5.

FIG. 1 illustrates a delivery assistance device 40, a plurality of delivery vehicles 10, and a plurality of information terminals 20. In the present embodiment, the delivery assistance device 40 functions as a “delivery route creation device.”

### Delivery Vehicle and Information Terminal

The delivery vehicle 10 is a vehicle that delivers a package to a package receiving destination. The delivery vehicle 10 includes a cargo area 11. A plurality of cargoes can be loaded on the cargo area 11. In addition, the delivery vehicle 10 includes a position information acquisition unit 12 that acquires its own position information.

The information terminal 20 is a communication device carried by a delivery person riding the delivery vehicle 10. In the present embodiment, the delivery person corresponds to the “driver of the delivery vehicle 10.” The information terminal 20 is configured to communicate with the delivery assistance device 40 via the communication network 100. Examples of the information terminal 20 include a smartphone and a tablet terminal.

For example, the information terminal 20 includes a communication device 21, a user interface 23, and processing circuitry 25. The communication device 21 outputs information received from the delivery assistance device 40 via the communication network 100 to the processing circuitry 25. The communication device 21 transmits information output from the processing circuitry 25 to the delivery assistance device 40 via the communication network 100.

The user interface 23 includes a display screen and an operation unit. An example of the processing circuitry 25 is an electronic controller. When the operation unit is operated by the delivery person, the processing circuitry 25 executes processing corresponding to the operation. Further, when the communication device 21 receives information from the delivery assistance device 40 via the communication network 100, the processing circuitry 25 displays the information received by the communication device 21 on the display screen of the user interface 23.

### Delivery Assistance Device

The delivery assistance device 40 includes a communication device 41, a controller 43, a first database 47, and a second database 49.

The communication device 41 transmits and receives information to and from an external communication device via the communication network 100. That is, the communication device 41 is an interface of the delivery assistance device 40. For example, the communication device 41 outputs information received via the communication network 100 to the controller 43. Further, for example, the communication device 41 transmits information output by the controller 43 to the information terminal 20 via the communication network 100.

An example of the controller 43 is an electronic controller. In this case, the controller 43 has a CPU44 and a memory 45. The memory 45 stores a control program executed by the CPU44. When the CPU44 executes the control program, the controller 43 executes a process of creating a delivery route for delivering a package to a plurality of delivery destinations by the delivery vehicle 10. The contents of the creation processing will be described later.

Information necessary for the controller 43 to create a delivery route is recorded in each of the first database 47 and the second database 49.

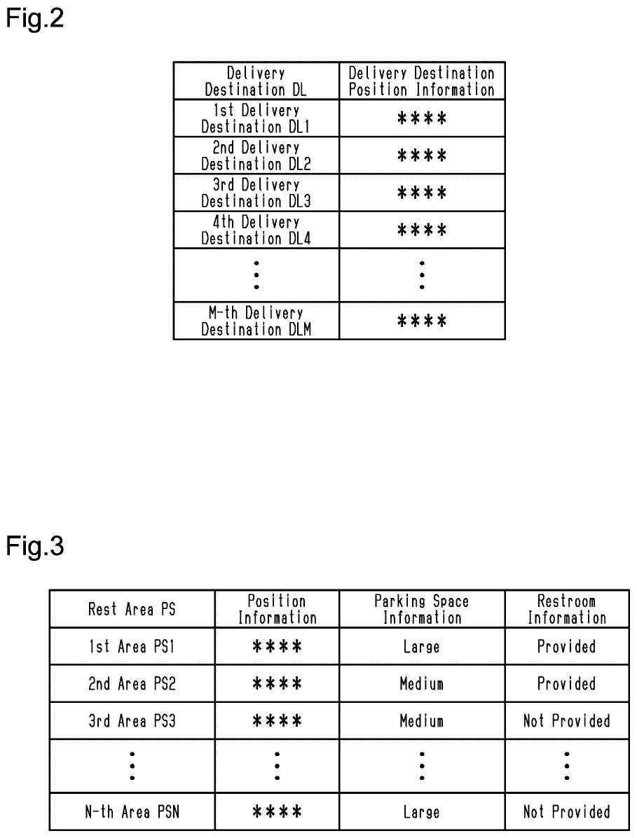

The information recorded in the first database 47 will be described with reference to FIG. 2.

Information relating to a plurality of delivery destinations DL is recorded in the first database 47. Specifically, the delivery destination position information of the plurality of delivery destinations DL is recorded in the first database 47. The delivery destination position information includes the address of the delivery destination DL. In the example illustrated in FIG. 2, delivery destination position information of M delivery destinations DL1, DL2, DL3, DL4, . . . , and DLM is recorded in the first database 47. Note that “M” is an integer of 5 or more.

The information recorded in the second database 49 will be described with reference to FIG. 3.

In the second database 49, position information of a plurality of rest areas PS is recorded. The rest area PS is a place which has a parking space where a vehicle such as the delivery vehicle 10 can be parked and where a driver of the vehicle can take a rest. As the rest area, for example, a park having a parking lot and a commercial facility such as a convenience store having a parking lot can be exemplified. In the example illustrated in FIG. 3, the N rest areas include a first area PS1, a second area PS2, a third area PS3, . . . , and an N-th area PSN. Note that “N” is an integer of 4 or more.

The parking space information of a plurality of rest areas PS is recorded in the second database 49. The parking space information is information related to the size of the parking space prepared in the rest area PS. Depending on the width of the parking space and the size of the delivery vehicle 10, the delivery vehicle 10 may not be parked in the parking space. Therefore, the parking space information for each of the rest areas PS1 to PSN is recorded in the second database 49. In the example illustrated in FIG. 3, the parking space information of the first location PS1 indicates that the parking space is wide. Therefore, even a relatively large delivery vehicle 10 can be parked in the parking space of the first location PS1. The parking space information of the second location PS2 indicates that the parking space is medium. Therefore, while a relatively large delivery vehicle 10 cannot be parked in the parking space of the second location PS2, a relatively small delivery vehicle 10 can be parked therein.

In the second database 49, restroom information of a plurality of rest areas PS is recorded. The restroom information is information related to whether or not a restroom is installed in the rest area PS. In the example illustrated in FIG. 3, the restroom information of the first location PS1 and the second location PS2 indicates that a restroom is installed. On the other hand, the restroom information of the third location PS3 and the N-th location PSN respectively indicate that no restroom is installed.

### Delivery Route Creation Processing

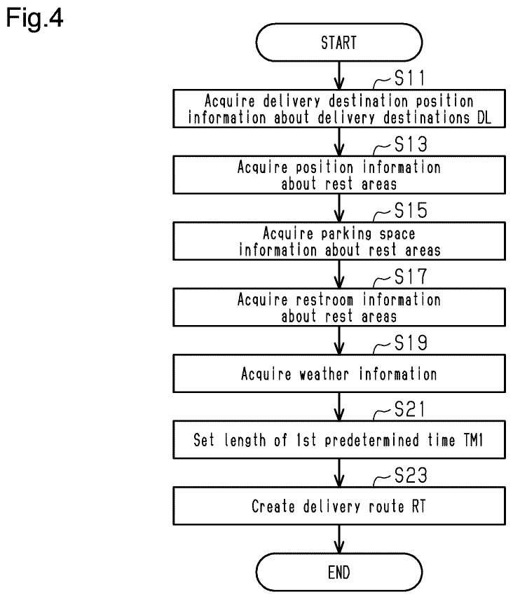

The above-described delivery route creation processing will be described with reference to FIG. 4. A plurality of processes constituting the creation process are executed by the controller 43 of the delivery assistance device 40.

In step S11, the controller 43 acquires delivery destination position information of a plurality of delivery destinations DL for which a predetermined delivery vehicle 10 is in charge among the plurality of delivery vehicles 10 from the first database 47. For example, the controller 43 acquires the delivery destination position information of the plurality of delivery destinations DL included in the predetermined delivery area.

In the next step S13, the controller 43 acquires the position information of the plurality of rest areas PS from the second database 49. For example, the controller 43 acquires the position information of the plurality of rest areas PS in the predetermined delivery area among the plurality of rest areas PS1 to PSN recorded in the second database 49. The plurality of rest areas PS acquired from the second database 49 in step S13 are referred to as “candidate area PSA.”

In subsequent step S15, the controller 43 acquires the parking space information of the plurality of candidate places PSA from the second database 49. Further, in step S17, the controller 43 acquires the restroom information of the plurality of candidate places PSA from the second database 49.

In the next step S19, the controller 43 acquires weather information which is information relating to weather on the delivery date. In step S21, the controller 43 sets the first predetermined time S19 on the basis of the weather information acquired in step TM1. For example, in a case where the delivery person drives the delivery vehicle 10 when it is raining, the burden on the delivery person due to the driving of the delivery vehicle 10 is likely to be larger than in a case where the delivery person drives the delivery vehicle 10 when it is not raining. It is preferable to increase the rest frequency of the delivery person as the burden on the delivery person increases. Therefore, for example, when it can be predicted that it will rain during delivery, the controller 43 sets the first predetermined time TM1 so that the first predetermined time TM1 corresponding to the work time between rests is shorter than when it is not predicted that it will rain during delivery.

In subsequent step S23, the controller 43 creates the delivery route RT for the predetermined delivery vehicle 10 on the basis of the delivery destination position information of the plurality of delivery destinations DL, the position information of the plurality of candidate places, the parking space information of the plurality of candidate places, and the restroom information of the plurality of candidate places. For example, the controller 43 creates a route satisfying all of the following conditions (A1) to (A4) as the delivery route RT. The second predetermined time TM2 is, for example, twice as long as the first predetermined time TM1.

(A1) Delivering goods to the delivery destinations DL acquired in step S11.

(A2) Allowing a predetermined delivery vehicle 10 to go to the rest area PS at each first predetermined time TM1.

(A3) Allowing a predetermined delivery vehicle 10 to go to the rest area PS at a predetermined rest time.

(A4) Allowing a predetermined delivery vehicle 10 to go to a rest area PS provided with a restroom at each second predetermined time TM2.

In order for the delivery person to take a rest during the delivery, it is necessary to park a predetermined delivery vehicle 10. That is, the predetermined delivery vehicle 10 goes to the rest area PS having a parking space large enough to park the predetermined delivery vehicle 10, so that the delivery person can take a rest.

Therefore, the controller 43 excludes a place where the predetermined delivery vehicle 10 cannot be parked from the plurality of candidate places PSA. The delivery destination to which the predetermined delivery vehicle 10 is directed immediately before the time at which the delivery person is caused to take a rest during delivery is referred to as an immediate delivery destination DLA, and the delivery destination to which the predetermined delivery vehicle 10 is directed next to the immediate delivery destination DLA is referred to as an immediate delivery destination DLB. At this time, the controller 43 selects the candidate place PSA located near both the immediately preceding delivery destination DLA and the immediately following delivery destination DLB from among the plurality of candidate places PSA. Then, the controller 43 creates the delivery route RT such that the predetermined delivery vehicle 10 heads for the immediate delivery destination DLB after the predetermined delivery vehicle 10 that has delivered the package to the immediate delivery destination DLA arrives at the selected candidate place PSA. Accordingly, the controller 43 can create the delivery route RT satisfying all of the conditions (A1), (A2), and (A3).

Note that the controller 43 selects a rest area PS where a restroom is installed as the rest area PS to which a predetermined delivery vehicle 10 goes every second predetermined time TM2. Thus, the controller 43 can create the delivery route RT that also satisfies the condition (A4).

### Update of Information Recorded in Second Database

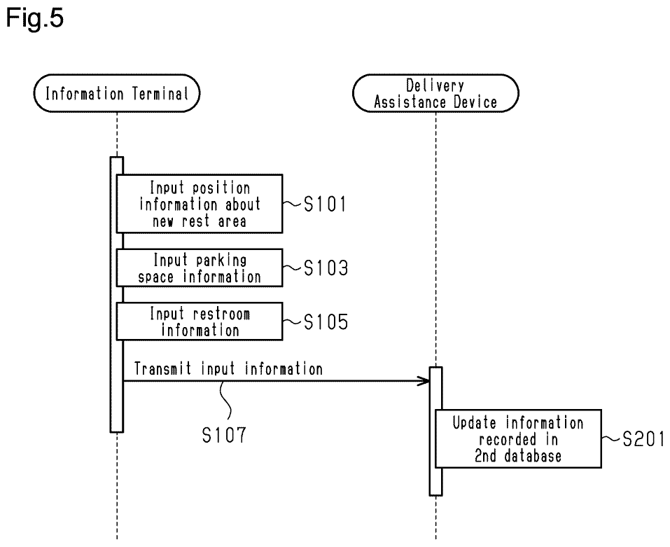

With reference to FIG. 5, a flow of a process of updating the information recorded in the second database 49 will be described.

It is assumed that the delivery person finds a new rest area PS while driving the delivery vehicle 10. The new rest area PS is an area that is not recorded in the second database 49. At this time, the delivery person operates his/her own information terminal 20 to record the information on the new rest area PS in the second database 49.

That is, in step S101, the processing circuitry 25 of the information terminal 20 causes the display screen of the user interface 23 to display an input screen for allowing the delivery person to input the position information of the new rest area PS. Then, the delivery person operates the operation unit of the user interface 23 to input, for example, the address of the new rest area PS as the position information of the new rest area PS. When the position information of the new rest area PS is input by the delivery person, the processing circuitry 25 shifts the processing to step S103.

In step S103, the processing circuitry 25 displays an input screen for allowing the delivery person to input the parking space information of the new rest area PS on the display screen of the user interface 23. Then, the delivery person inputs the parking space information of the new rest area PS by operating the operation unit of the user interface 23. When the parking space information is input by the delivery person, the processing circuitry 25 shifts the processing to step S105.

In step S105, the processing circuitry 25 causes the display screen of the user interface 23 to display an input screen for causing the delivery person to input restroom information of the new rest area PS. Then, the delivery person inputs the restroom information of the new rest area PS by operating the operation unit of the user interface 23. When the restroom information is input by the delivery person, the processing circuitry 25 shifts the processing to step S107.

In step S107, the communication device 21 of the information terminal 20 transmits the information input by the delivery person, that is, the position information of the new rest area PS, the parking space information, and the restroom information to the delivery assistance device 40.

When the communication device 41 of the delivery assistance device 40 receives the information regarding the new rest area PS from the information terminals 20, the controller 43 of the delivery assistance device 40 executes the process of step S201.

In step S201, the controller 43 updates the information recorded in the second database 49 by adding the information regarding the new rest area PS to the second database 49.

### Operation and Advantages of Present Embodiment

(1) The controller 43 creates a delivery route RT based on the delivery destination position information about the delivery destinations assigned to the delivery vehicle 10 and the position information about the rest area PS. Specifically, the controller 43 creates the delivery route RT that satisfies all of the conditions (A1) to (A3) described above.

The delivery vehicle 10 performs the delivery task in accordance with the delivery route RT created by the delivery assistance device 40. Thus, the delivery vehicle 10 regularly passes near the rest area PS during the delivery. This allows the delivery person riding the delivery vehicle 10 to park the delivery vehicle 10 at the rest area PS and appropriately take a rest.

Therefore, the delivery assistance device 40 allows the delivery person to appropriately take a rest during the delivery while delivering goods using the delivery vehicle 10.

(2) The controller 43 creates a delivery route RT such that the delivery vehicle 10 periodically passes near the rest area PS that includes a parking space large enough to park the delivery vehicle 10. Thus, the delivery assistance device 40 reduces the occurrence of a situation in which the delivery person cannot park the delivery vehicle 10 in a parking space and, therefore, cannot take a rest.

(3) The controller 43 creates a delivery route RT that allows the delivery vehicle 10 to go to a rest area PS provided with a restroom at each second predetermined time TM2. When performing the delivery task in accordance with the delivery route RT, the deliver person can go to the restroom in an appropriate manner.

(4) The controller 43 adjusts the length of the first predetermined time TM1 in accordance with the weather. Accordingly, the delivery assistance device 40 adjusts the timing at which the delivery person takes a rest in accordance with changes in the load on the delivery person according to the weather.

(5) When the delivery person finds a new rest area PS during the delivery, the delivery person input information about the new rest area PS using the information terminal 20. When the information is transmitted from the information terminal 20 to the delivery assistance device 40, the information recorded in the second database 49 is updated. With the update of the information recorded in the second database 49, when the controller 43 creates a delivery route RT in the future, the delivery route RT allows the delivery person to take a rest more easily.

### Modified Examples

The above-described embodiment may be modified as follows. The above-described embodiment and the following modifications can be combined as long as the combined modifications remain technically consistent with each other.

The controller 43 may not change the first predetermined time TM1 depending on the weather.

The controller 43 may create the delivery route RT without considering the restroom information. In this case, the restroom information of the rest area PS may not be recorded in the second database 49.

The controller 43 may create the delivery route RT without considering the parking space information. In this case, the parking space information of the rest area PS may not be recorded in the second database 49.

If both of the above conditions (A1) and (A2) can be satisfied, the controller 43 may create a route that does not satisfy the above condition A3 as the delivery route RT.

If both of the above conditions (A1) and (A3) can be satisfied, the controller 43 may create a route that does not satisfy the above condition A2 as the delivery route RT.

It is not essential for the controller 43 to update the information recorded in the second database 49 based on the information transmitted from the information terminal 20 to the delivery assistance device 40. The controller 43 may update the information recorded in the second database 49 by a method different from the method illustrated in FIG. 5.

The controller 43 is not limited to a device that includes a CPU and a ROM and executes software processing. That is, the controller 43 may have any one of the following configurations (a), (b), and (c).

(a) The controller 43 includes one or more processors that execute various processes according to computer programs. Each processor includes a CPU and a memory, such as a RAM and a ROM. The memory stores program codes or instructions configured to cause the CPU to execute processes. The memory, which is a computer-readable medium, includes any type of media that are accessible by general-purpose computers and dedicated computers.

(b) The controller 43 includes one or more dedicated hardware circuits that execute various processes. The dedicated hardware circuits include, for example, an application specific integrated circuit (ASIC) and a field programmable gate array (FPGA). Note that ASIC is an abbreviation of “Application Specific Integrated Circuit,” and FPGA is an abbreviation of “Field Programmable Gate Array.”

(c) The controller 43 includes a processor that executes part of various processes according to programs and a dedicated hardware circuit that executes the remaining processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A delivery route creation device that creates a delivery route for delivering goods to delivery destinations by a delivery vehicle, the delivery route creation device, comprising:
a database that records position information about a rest area including a parking space in which the delivery vehicle is allowed to be parked, the rest area being an area in which a driver of the delivery vehicle is allowed to rest; and
a controller including processing circuitry, wherein
based on position information about the delivery destinations and the position information about the rest area, the processing circuitry is configured to create a route, as the delivery route, that satisfies both
delivering the goods to the delivery destinations, and
allowing the delivery vehicle to go to the rest area at each predetermined time interval or at a predetermined rest time.

2. The delivery route creation device according to claim 1, wherein
the database further includes parking space information that is information about a size of the parking space in the rest area, the rest area including multiple rest areas, and
based on the position information about the delivery destinations, the position information about the rest areas, and the parking space information, the processing circuitry is configured to create a route, as the delivery route, that satisfies both
delivering the goods to the delivery destinations, and
allowing the delivery vehicle to go to, among the rest areas, a rest area that includes the parking space in which the delivery vehicle is allowed to be parked at each predetermined time interval or at a predetermined rest time.

3. The delivery route creation device according to claim 1, wherein
the database includes restroom information that is information about whether the rest area is provided with a restroom usable by the driver,
based on the position information about the delivery destinations, the position information about the rest area, and the restroom information, the processing circuitry is configured to create a route, as the delivery route, that satisfies both
delivering the goods to the delivery destinations, and
allowing the delivery vehicle to go to the rest area provided with the restroom at each predetermined time interval.

4. The delivery route creation device according to claim 1, wherein the processing circuitry is configured to adjust a length of the predetermined time interval in accordance with weather.

5. The delivery route creation device according to claim 1, further comprising:
a communication device configured to communicate with an information terminal carried by the driver of the delivery vehicle, wherein
when the driver finds a new rest area, the information terminal is configured to transmit position information about the new rest area to the delivery route creation device, and
when the communication device receives the position information about the new rest area from the information terminal, the processing circuitry is configured to add the position information about the new rest area to the database.
